(19) United States
(12) Patent Application Publication
(10) Pub. No.: US 2009/0131000 A1
(43) Pub. Date: May 21, 2009

(54) RADIO RECEIVER SYSTEM

(76) Inventors: Yao H. Kuo, West Bloomfield, MI (US); James E. Brewer, Plymouth, MI (US); Tom P. Moyles, Livonia, MI (US); Gary E. Zack, Novi, MI (US); Paul T. Schreiber, Ypsilanti, MI (US)

Correspondence Address: VISTEON/BRINKS HOFER GILSON & LIONE, 524 South Main Street, Suite 200, Ann Arbor, MI, 48104, US

(21) Appl. No.: 11/944,120

(22) Filed: Nov. 21, 2007

(51) Int. Cl. H04B 1/06

(52) U.S. Cl. 455/130

(57) ABSTRACT

An oscillation circuit for a radio receiver system. The oscillator circuit includes a tank circuit, a first and second transistor, and a first and second low pass filter. The first transistor forms a first current loop when the first transistor is active. Similarly, the second transistor forms a second current loop when the second transistor is active. The first low pass filter is connected in an electrical series connection within the first current loop and the second low pass filter is connected in an electrical series connection within the second current loop. As such, the first and second low pass filter serve to reduce the gain of the oscillator circuit below a secondary resonant frequency of the tank circuit to prevent an oscillation condition, thereby preventing unwanted oscillations at a secondary resonant frequency.

### BACKGROUND

1. Field of the Invention

The present invention generally relates to a radio receiver system.

2. Description of Related Art

Tank circuits have been used for many years to generate an oscillator output that is combined with a radio frequency signal to generate an intermediate frequency signal. Generally, these types of tank circuits use inductors and capacitors to form a band pass filter with a variable frequency band. However, manufacturing tolerances and changes in circuit performance over time can lead to variations in the electrical characteristics, tuning frequency, and the performance of a tank circuit. In addition, the impedance of inductors generally increases with frequency. However, above an inductor resonant frequency the inductor will decrease in impedance. Similarly, a capacitor generally decreases in impedance as the frequency increases. However, above a capacitive resonant frequency the capacitor will increase in impedance as frequency continues to increase. As such, while the capacitor and inductor are chosen to provide a desired resonant frequency within the tank circuit, secondary unwanted resonant frequencies can occur as a result. These higher unwanted frequencies can cause distortion in the intermediate frequency signal and degrade performance of the system.

In view of the above, it is apparent that there exists a need for an improved radio receiver system.

### SUMMARY

In satisfying the above need, as well as overcoming the enumerated drawbacks and other limitations of the related art, the present invention provides an improved radio receiver system.

The system includes an antenna, a mixer, and oscillator circuit. The antenna receives a radio frequency (RF) signal that is provided to the mixer. The oscillator circuit provides an oscillator output signal to the mixer that is combined with the RF signal to generate an intermediate frequency signal that may be further demodulated to generate an audio output signal. The oscillator circuit includes a tank circuit, a first and second transistor, and a first and second low pass filter. The first transistor forms a first current loop when the first transistor is active. Similarly, the second transistor forms a second current loop when the second transistor is active. The first low pass filter is connected in an electrical series connection within the first current loop and the second low pass filter is connected in an electrical series connection within the second current loop. As such, the first and second low pass filter serve to reduce the gain of the oscillator circuit below a secondary resonant frequency of the tank circuit to prevent an oscillation condition, thereby preventing unwanted oscillations at a secondary resonant frequency.

In another aspect of the invention, a base of the first transistor is connected to a collector of the second transistor where the first low pass filter is connected in an electrical series connection between the base of the first transistor and the collector of the second transistor. Similarly, the base of the second transistor is connected to a collector of the first transistor and the second low pass filter is connected in an electrical series connection between the base of the second transistor and the collector of the first transistor. In addition, the first low pass filter may be connected between the base of the first transistor and the tank circuit.

In another aspect of the invention, the first low pass filter is connected between the collector of the first transistor and a first differential oscillator output. Similarly, the second low pass filter is connected between the collector of the second transistor in a second differential oscillator output. As such, the first and second low pass filter reduces the gain at a secondary oscillation frequency of the tank circuit to prevent a secondary oscillation condition at the secondary oscillation frequency.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for a radio receiver having improved oscillation characteristics.

FIG. 2 is a schematic view illustrating the first current loop from FIG. 1.

FIG. 3 is a schematic view illustrating the second current loop from FIG. 1.

FIG. 4 is a schematic view of an RC low pass filter.

FIG. 5 is a schematic view of an RLC low pass filter.

FIG. 6 is a graph illustrating a primary resonant frequency and secondary resonant frequency of a tank circuit in conjunction with system attenuation; and

FIG. 7 is a schematic view of another embodiment of a system for a radio receiver with improved oscillation.

### DETAILED DESCRIPTION

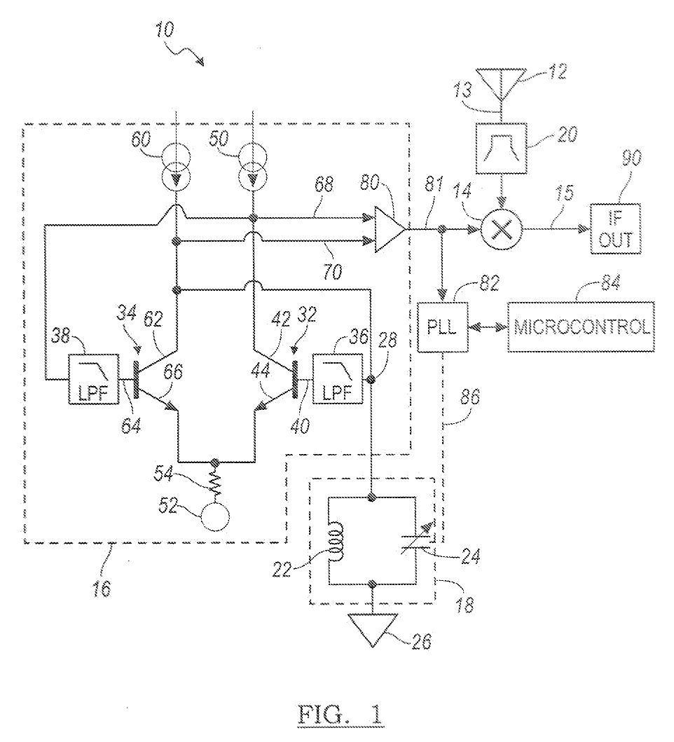

Referring now to FIG. 1, the system 10 includes an antenna 12, a mixer 14, and an oscillation circuit 16. The antenna 12 receives a radio frequency (RF) signal 13, such as a frequency modulated (FM) or amplitude modulated (AM) radio signal. The RF signal 13 is provided to a band pass filter 20 to reduce any noise that may fall outside of the expected radio frequency band. The RF signal 13 is provided from the band pass filter 20 to the mixer 14. The oscillation circuit 16 provides an oscillator output signal 81 to the mixer 14. The mixer 14 combines the radio frequency signal 13 with the oscillator output signal 81 to generate an intermediate frequency signal 15. The oscillator circuit 16 is initiated by a tank circuit 18. The tank circuit 18 includes an inductor 22 and a capacitor 24. The inductor 22 and capacitor 24 oscillate at a given frequency according the equation

$${F}_{c} = \frac{1}{2} π * \sqrt{LC} \qquad ( 1 )$$

where the frequency (F_{C}) is the desired frequency set by the user and corresponds to the desired radio station, L is the inductance of the inductor 22, and C is the capacitance of the capacitor 24. To tune the radio, the desired frequency (F_{C}) must be adjustable within the tank circuit 18. Accordingly, the capacitor 24 may be a voltage controlled capacitor such as a varactor. The inductor 22 and capacitor 24 are in electrical parallel connection. One side of the inductor 22 and capacitor 24 are connected together to a voltage reference 26. The other side of the inductor 22 and capacitor 24 are connected to the rest of the oscillator circuit at node 28.

The tank circuit 18 provides an oscillating voltage to node 28. The oscillator circuit 16 also includes a first transistor 32 and a second transistor 34. The first and second transistor 32, 34 provide the clean and consistent oscillator output signal 81 to the mixer 14 based on the oscillation of the tank circuit 18. The first and second transistors 32, 34 are shown as bipolar transistors, however, one of ordinary skill in the art would recognize that other transistors may also be used.

As shown in FIG. 1, the current source 50 is connected to the collector 42 of the transistor 32, while the emitter 44 of the transistor 32 is connected to a voltage reference 52 through resistor 54. The base 40 of the transistor 32 is connected to node 28 through a low pass filter 36. Node 28 is in electrical communication with the tank circuit 18 and the collector 62 of the second transistor 34. As such, the base 40 of the first transistor 32 is connected to both the tank circuit 18 and the collector 62 of the second transistor 34, allowing the first transistor 32 to become active when the oscillating voltage from the tank circuit 18 is high. The collector 62 of transistor 34 is connected to the current source 60. This parallels the connection between current source 50 and transistor 32. In addition, the emitter 66 of the second transistor 34 is electrical communication with the voltage reference 52 through resistor 54. The base 64 of transistor 34 is connected to the collector 42 of transistor 32 through the second low pass filter 38. As such, the second transistor 34 becomes active when the oscillating voltage from the tank circuit 18 is low.

These connections generate a first differential local oscillator output 68 and a second differential local oscillator output 70. As such, the first differential local oscillator output 68 is provided to the amplifier 80 through a connection with the base 64 of the second transistor 34 and the collector 42 of the first transistor 32. Similarly, the second differential local oscillator output 70 is provided to the amplifier 80 through a connection between the base 40 of the first transistor 32 and the collector 62 of the second transistor 34. The amplifier 80 provides an oscillator output signal 81 to the mixer 14, thereby generating an intermediate frequency signal 15 based on the radio frequency signal 13. The intermediate frequency signal 15 is provided to the demodulator 90 by the mixer 14. The demodulator 90 may then generate an audio output signal that may be provided to an audio output device, such as a speaker, recorder, or other audio system.

The oscillator output signal 81 is also provided to a phase locked loop 82. The phase locked loop 82 is communication with a microcontroller 84. The microcontroller 84 receives information from the user as to which station or frequency is requested. Accordingly, the microcontroller 84 provides data to the phase locked loop 82 as to which station or frequency is requested. The phase locked loop 82 generates a tuning voltage 86 that is provided to the tank circuit 18 to control the voltage controlled capacitor 24. As such, the phase locked loop 82 adjusts the frequency at which the voltage from the tank circuit 18 oscillates.

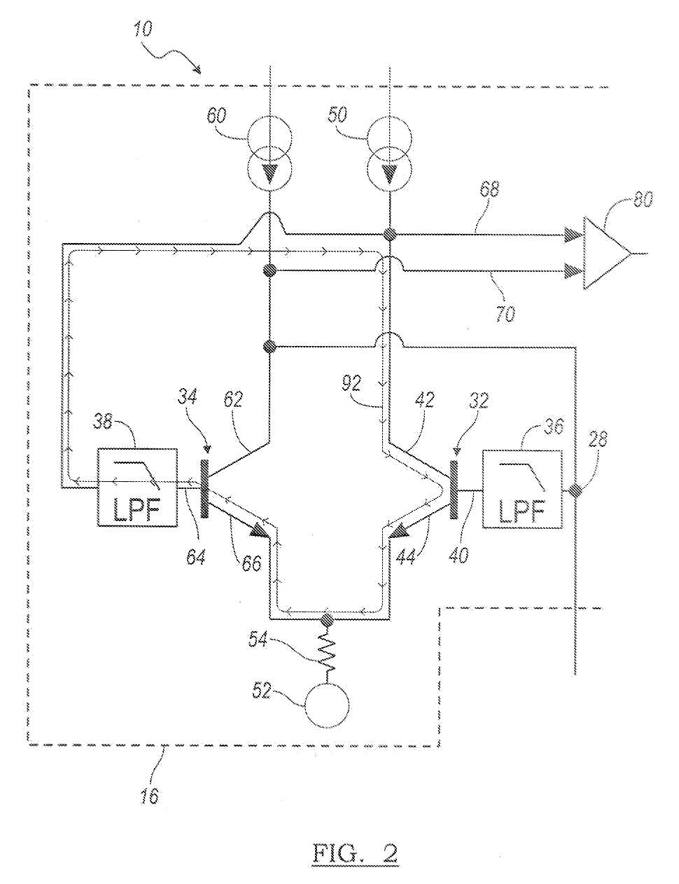

It should be noted that two current paths are created as the oscillator circuit 16 generates the oscillator output. The first current loop 92 is shown in FIG. 2. When the first transistor 32 is active current travels into collector 42, out of emitter 44, and into emitter 66. Then the current travels through base 64, through low pass filter 38, and back into collector 42 of the first transistor 32 generating the first current loop 92. Further, it should be noted that low pass filter 38 is connected in electrical series connection between the base 64 of the second transistor 34 and the collector 42 of the first transistor 32. Positioning the second low pass filter 38 in an electrical series connection within the first current loop 92 serves to prevent unwanted oscillation at a second resonant frequency of the tank circuit 18.

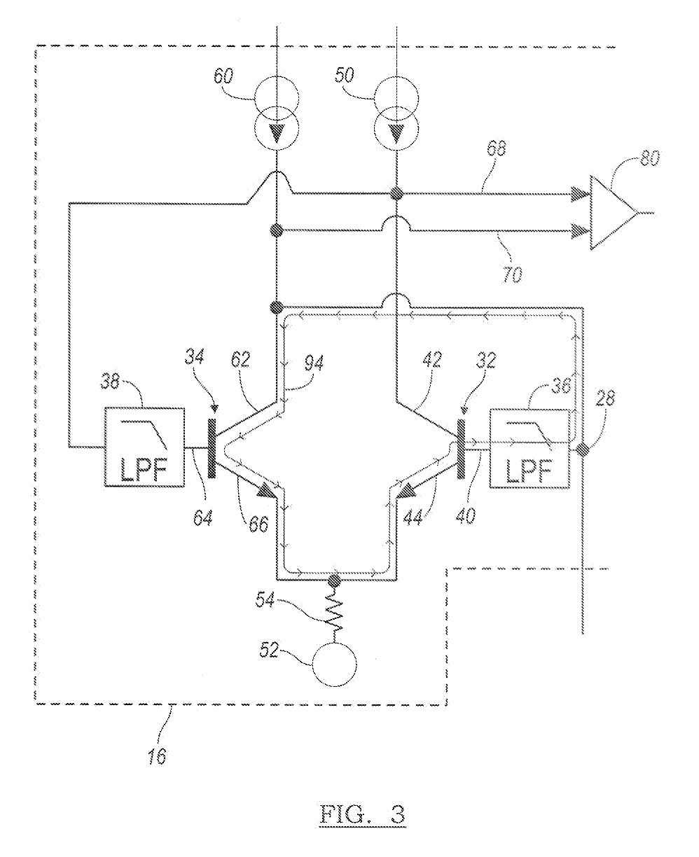

Similarly, when the second transistor 34 is active a second current loop 94 is created as shown in FIG. 3. In the second current loop 94, current flows into the collector 62 and out of the emitter 66 second transistor 34. Then the current flows into the emitter 44 of the first transistor 32, out of the base 48 of the first transistor 32, and through the first low pass filter 36, thereby closing the second current loop 94 back to collector 62 of the second transistor 34. It should be noted that the first low pass filter 36 is connected in an electrical series connection within the second current loop 94. More specifically, connecting the first low pass filter 36 between the base 40 of first transistor 32 and the collector 62 of the second transistor 34 serves to prevent unwanted oscillation at the second resonant frequency of the tank circuit 18.

The first and second low pass filter 36, 38 may take the form of an RC or RLC filter. In case of an RC filter as shown in FIG. 4, capacitor 102 would be connected between the base 40 of the first transistor 32 and a voltage reference 106. A resistor 104 would have a first side connected to the base 40 and capacitor 102, while the second side of the resistor 104 would be connected to node 28. As such, capacitor 102 and resistor 104 would be connected in an electrical parallel connection. This would be implemented in the same matter with respect to the second low pass filter 38 relative to the second transistor 34.

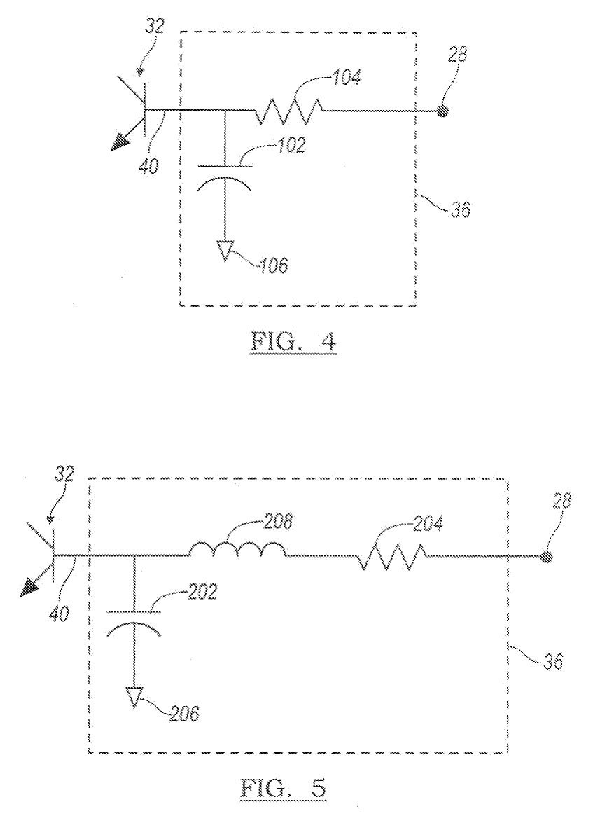

In the case of an RLC low pass filter the base 40 of transistor 32 would be connected in an electrical series connection with an inductor 208 and a resistor 204 between the base 40 and node 28. This configuration is shown in FIG. 5. Similar to the RC circuit, the capacitor 202 would be connected between the base 40 of the first transistor 32 and voltage reference 206. In addition, the capacitor 202 would be connected in an electrical parallel connection with both the inductor 208 and the resistor 204.

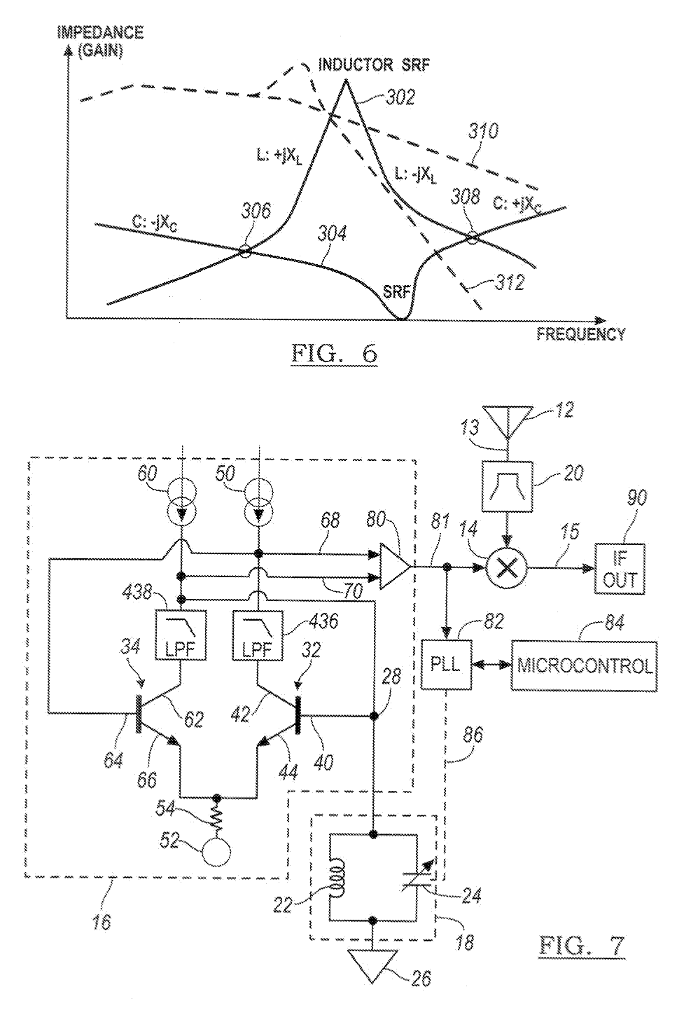

The value of the capacitors and resistors in the local pass filter 38, 34 are selected to significantly reduce the gain at the second oscillation frequency of the tank circuit 18, dropping the voltage below viable oscillation conditions. This can be better understood in reference to FIG. 6. For the tank circuit 18, the inductor 22 has impedance that varies with frequency according to line 302. Similarly, line 304 represents the impedance of capacitor 24 with respect to frequency. Where the impedance of the inductor 22 and capacitor 24 match at point 306 the tank circuit 18 will resonate at the corresponding frequency. The gain response of the tank circuit 18 is illustrated by line 310. Accordingly, the system has a high gain at the desired resonant frequency denoted by 306. However, beyond an inductor resonant frequency, the impedance of the inductor 22 will begin to decrease. Similarly, the impedance of the capacitor 24, beyond a capacitive resonant frequency, will begin to increase. As such, the impedance of the inductor 22 and the capacitor 24 may also generate a secondary resonant frequency, designated by reference numeral 308, at a much higher frequency than the desired frequency 306. As such, the low pass filters 36, 38 provide an attenuation response shown by line 312. Accordingly, the frequency gain is reduced to prohibit unwanted oscillations above a predetermined frequency, where the predetermined frequency is between the desired resonant frequency 306 and the secondary resonant frequency 308 of the tank circuit 18. Accordingly, the gain at the secondary oscillation frequency 308 is attenuated below oscillation conditions, while a high gain is provided at the primary resonant frequency 306 of the tank circuit 18.

Now referring to FIG. 7, another embodiment of the system is provided. Like elements for FIG. 1 are numbered according to their use in FIG. 1. However, in FIG. 7, the low pass filters 38 and 36 from FIG. 1 have been removed. Alternatively, a first low pass filter 436 and a second low pass filter 438 have been implemented. Although the first and second low pass filter 436, 438 may be of the same type as described above with respect to low pass filters 36, 38 in FIG. 1, the first and second low pass filter 436, 438 are provided in different locations within the first and second current loop. As such, the first low pass filter 436 is connected to the collector 42 of the first transistor 32 on a first end and the base 64 of the second transistor 34 on a second end. In addition, the base of transistor 32 is connected to node 28. Also, the base of transistor 32 is connected to the collector 62 of transistor 34 through node 28 and the second low pass filter 438. While the location of the low pass filters have changed, the first and second current loops operate in a similar fashion as is shown in FIGS. 2 and 3.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

We claim:

1. A system for a radio receiver, the system comprising:
an antenna input for receiving an RF signal;
a mixer in communication with the antenna input to receive the RF signal;
an oscillator circuit in communication with the mixer to provide an oscillator output signal, the mixer being configured to generate an intermediate frequency signal from the oscillator output signal and the RF signal;
wherein the oscillator circuit comprises a tank circuit, a first transistor, a second transistor, a first low pass filter, and a second low pass filter, the first transistor forming a first current loop when the first transistor is active, the second transistor forming a second current loop when the second transistor is active; the first low pass filter being connected in electrical series connection within the second current loop and the second low pass filter being connected in electrical series connection within the first current loop.

2. The system according to claim 1, wherein the first transistor is active when a tank circuit oscillation signal is high.

3. The system according to claim 1, wherein the second transistor is active when a tank circuit oscillation signal is low.

4. The system according to claim 1, wherein the first and second transistors generate a differential oscillator output signal.

5. The system according to claim 1, wherein a base of the first transistor is in communication with a collector of the second transistor and a base of the second transistor is in communication with a collector of the first transistor.

6. The system according to claim 5, wherein the first low pass filter is connected in electrical series connection between the base of the first transistor and the collector of the second transistor.

7. The system according to claim 6, wherein the second low pass filter is connected in electrical series connection between the base of the second transistor and the collector of the first transistor.

8. The system according to claim 7, wherein the first low pass filter is connected between the base of the first transistor and the tank circuit.

9. The system according to claim 1, wherein the second low pass filter is connected between the collector of the first transistor and a first differential oscillator output.

10. The system according to claim 9, wherein the first low pass filter is connected between the collector of the second transistor and a second differential oscillator output.

11. The system according to claim 1, wherein the first and second low pass filter reduces the gain at a secondary oscillation frequency of the tank circuit to prevent a secondary oscillation condition at the secondary oscillation frequency.

12. An oscillator circuit for a radio receiver, the oscillator circuit comprising:
a tank circuit;
a first transistor forming a first current path when the first transistor is active;
a second transistor forming a second current path when the second transistor is active;
a first low pass filter being connected in electrical series connection within the second current loop; and
a second low pass filter being connected in electrical series connection within the first current loop.

13. The circuit according to claim 12, wherein the first transistor is active when a tank circuit oscillation signal is high.

14. The circuit according to claim 12, wherein the second transistor is active when a tank circuit oscillation signal is low.

15. The circuit according to claim 12, wherein the first and second transistors generate a differential oscillator output signal.

16. The circuit according to claim 12, wherein a base of the first transistor is in communication with a collector of the second transistor and a base of the second transistor is in communication with a collector of the first transistor.

17. The circuit according to claim 12, wherein the first low pass filter is connected in electrical series connection between the base of the first transistor and the collector of the second transistor.

18. The circuit according to claim 12, wherein the second low pass filter is connected in electrical series connection between the base of the second transistor and the collector of the first transistor.

19. The circuit according to claim 12, wherein the first low pass filter is connected between the base of the first transistor and the tank circuit.

20. The circuit according to claim 12, wherein the first low pass filter is connected between the collector of the first transistor and a first differential oscillator output.

21. The circuit according to claim 12, wherein the second low pass filter is connected between the collector of the second transistor and a second differential oscillator output.

22. The circuit according to claim 12, wherein the first and second low pass filter reduces the gain at a secondary oscillation frequency of the tank circuit to prevent a secondary oscillation condition at the secondary oscillation frequency.
